(19) United States
(12) Patent Application Publication
(10) Pub. No.: US 2003/0179965 A1
(43) Pub. Date: Sep. 25, 2003

(54) Slide bearing

(76) Inventors: Andreas Ewert, Lichtenau (DE); Bernd Wieland, Gaggenau (DE)

Correspondence Address: Striker Striker & Stenby, 103 East Neck Road, Huntington, NY, 11743, US

(21) Appl. No.: 10/221,883

(22) PCT Filed: Dec. 12, 2001
(86) PCT No.: PCT/DE01/04661

(30) Foreign Application Priority Data
Jan. 18, 2001 (DE) 101 02 012.0

(51) Int. Cl. F16C 33/02

(52) U.S. Cl. 384/279

(57) ABSTRACT

In a slide bearing of the prior art, any lubricant present is lost at the two outer axial ends of the bearing.

In a slide bearing (1) of the invention, there are hollow chambers (22) at both outer axial ends (15, 17), which by the capillary effect cause escaping lubricant (25) to be stored in the hollow chamber (22).

### PRIOR ART

U.S. Pat. No. 6,049,983 shows a sintered slide bearing which has hollow chambers in the circumferential direction on both axial ends of the sintered slide bearing. However, these hollow chambers do not serve to store escaping lubricant. For that purpose, a hollow chamber is used which is present centrally in the sintered bearing and is bounded in both axial directions by a running face of the sintered slide bearing. Lubricant escaping from the outer side faces is no longer available for lubrication, and also soils other components.

From Japanese Patent Disclosure JP 07067282 A1, an armature with a bearing is known, which when the rotor shaft is mounted has an indentation on the face end. The slow leakage of fluid from a bearing is prevented, however, especially by means of an additional, fluid-absorbing material.

### ADVANTAGES OF THE INVENTION

The slide bearing of the invention having the definitive characteristics of claim 1 has the advantage over the prior art that in a simple way, on the two outer side faces that axially define the running face of the slide bearing, escaping lubricant is stored so that it can be returned for instance to the running face again.

By the provisions recited in the dependent claims, advantageous refinements of and improvements to the slide bearing recited in claim 1 are possible.

It is advantageous if an end face of the hollow chamber forms an angle of intersection other than 90° with the shaft, because this reinforces the capillary effect in that region.

The slide bearing is advantageously a sintered slide bearing, since the existing pores form a reservoir for a lubricant.

### DRAWING

Exemplary embodiments of the invention are shown in simplified in the drawing and described in further detail in the ensuing description.

FIGS. 1a,b show exemplary embodiments of a slide bearing embodied according to the invention.

### DESCRIPTION OF THE EXEMPLARY EMBODIMENTS

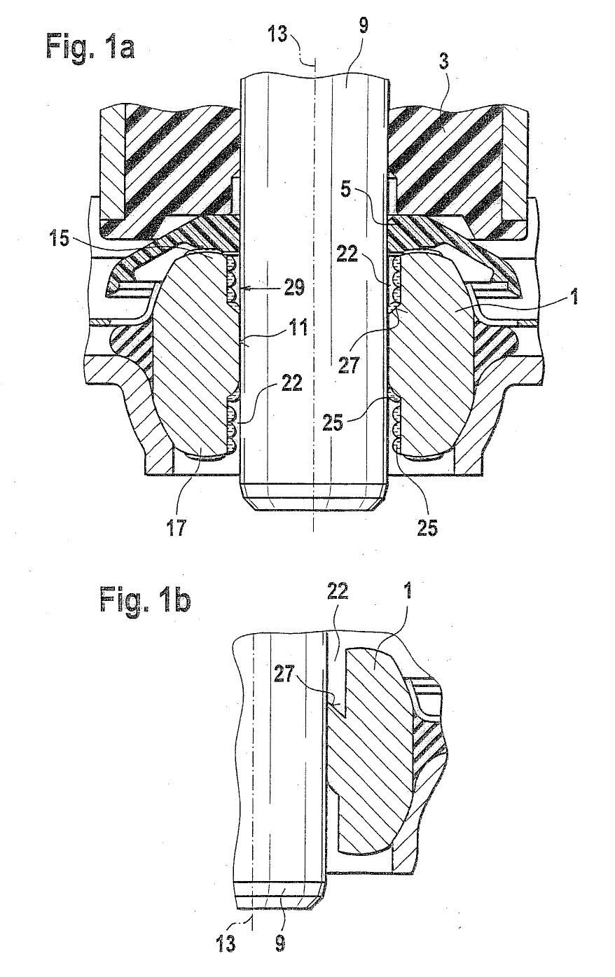

FIG. 1a shows a slide bearing 1 embodied according to the invention, which is present in a component 3, for instance a crankcase or gearbox, an electrical machine, or an electrical drive system. For example, the slide bearing 1 can also be a ball bearing.

A fastening means 5 is for instance present, by which the slide bearing 1 is secured in the component 3. Other types of fastening are also possible.

A shaft 9 is supported in the slide bearing 1. The support of the shaft 9 in the slide bearing 1 is effected via the contact face or slide face, that is, a running face 11 between the shaft 9 and the slide bearing 1.

The shaft 9 and the slide bearing 1 have an axis of symmetry 13 in the axial direction.

The running face 11 of the slide bearing 1 is for instance disposed centrally in the axial direction. One hollow chamber 22 each is located between the shaft 9 and the slide bearing 1, beginning at a first outer axial end 15 of the slide bearing 1 and at a second outer axial end 17 of the slide bearing.

The hollow chamber 22 for instance completely surrounds the shaft 9 in the circumferential direction.

Besides the hollow chamber 22, the slide bearing 1 for instance has other openings or indentations, in which a lubricant is placed.

The slide bearing 1 involves a porous material, for instance, which is saturated with a lubricant, such as oil. By way of example, the porous slide bearing 1 is produced by sintering and is accordingly a sintered bearing.

When the slide bearing 1 is in use, heating and the different coefficients of expansion of the lubricant and the slide bearing 1 cause oil droplets 25 to be forced out of the openings or pores in the slide bearing 1. In slide bearings of the prior art, this oil is lost, because it slowly leaks away from the slide bearing 1 along the shaft 9.

In the slide bearing 1 of the invention, this oil 25 is stored in the hollow chamber 22. For that purpose, the hollow chamber 22 has a certain axial length. The hollow chamber 22 has a cross section in the axial direction that is for instance constant and correspondingly small, so that a capillary effect ensues. As a result of the well-known capillary effect, additional forces arise, which keep the oil 25 in the hollow chamber 22, so that the oil 25 is not lost but instead can migrate back to the running face 11 or can be stored in the slide bearing again. The hollow chamber 22 is adapted in its dimensions to the surface tensions of the lubricant and of the materials present.

In the prior art, there are extra protection devices or tabs that prevent this oil from being distributed within the component 3. In the slide bearing 1 of the invention, this is unnecessary, since the oil 25 is retained in the hollow chamber 22 by the capillary effect.

The hollow chamber 22 has an end face 27, which defines the hollow chamber 22 in the axial direction 13 toward the running face 11. The end faces 27 can extend in a radial direction 29, or they can form an angle of intersection of other than 0, for instance of 45°, with the radial direction 29. As a result, the cross section of the hollow chamber 22 is reduced still further in this region, thus increasing the capillary effect in this region and causing the oil 25 to be quasi-aspirated into the hollow chamber 22. The end face 27 is inclined toward the middle, that is, in such a way that it narrows the hollow chamber 22 toward the running face 11.

FIG. 1b shows a further exemplary embodiment of the slide bearing 1 of the invention, in which the end face 27 is inclined toward an outer axial end 15, 17.

The axial length of the slide bearing 1 is 11 mm, for instance, and the length of the two hollow chambers 22 is 3 mm; that is, the axial length of the running face 11 is then approximately 5 mm.

The material of the slide bearing is sintered iron, sintered steel, sintered bronze, or some other powder metallurgical material.

1. A slide bearing,
in which a shaft is supported,
having at least one hollow chamber between the shaft and the bearing, which chamber is disposed on at least one axial end of the bearing in the circumferential direction, characterized in that the hollow chamber (22) is embodied as elongated in the axial direction (13), so that a capillary effect occurs there.

2. The slide bearing of claim 1, characterized in that the hollow chamber (22) has an end face (27), which defines the hollow chamber (22) in the axial direction (13), and that the end face (27) does not extend in the radial direction (29).

3. The slide bearing of claim 2, characterized in that the end face (27) forms an angle of 45° with the radial direction (29).

4. The slide bearing of claim 1, characterized in that the bearing (1) is a sintered bearing.

5. The slide bearing of claim 1, characterized in that the hollow chamber (22) completely surrounds the shaft (9) in the circumferential direction.
